(19) United States
(12) Patent Application Publication
(10) Pub. No.: US 2006/0004766 A1
(43) Pub. Date: Jan. 5, 2006

(54) Method for making system-specific information available to management software

(75) Inventor: Aaron E. Merkin, Holly Springs, NC (US)

Correspondence Address: DILLON & YUDELL LLP, 8911 NORTH CAPITAL OF TEXAS HWY, SUITE 2110, AUSTIN, TX, 78759, US

(73) Assignee: International Business Machines Corp., Armonk, NY (US)

(21) Appl. No.: 10/881,544

(22) Filed: Jun. 30, 2004

(51) Int. Cl. G06F 17/30

(52) U.S. Cl. 707/10

(57) ABSTRACT

A method and system that enables management software to quickly and efficiently access system specific information required for managing components/systems of a managed networked. Specifically, an automated process of generating the system definition and making the system definition available to system management software on a management server/system is provided as a component of the management software. A publicly available definitions database is provided that is readily available (and easily accessible) to the management server. The definitions database holds an updated list of definition files for all possible/designed component types that may be connected to the managed network. The management software executing on the management server/system is enhanced to include a utility that accesses a public (external) definitions database when required during a setup/registration of a managed component.

### BACKGROUND OF THE INVENTION

1. Technical Field

The present invention relates generally to computer systems and in particular to management of computer systems. Still more particularly, the preset invention relates to a method and system for improvement management of computer systems.

2. Description of the Related Art

The management of heterogeneous distributed computer systems is a complex task that can involve various operating systems, distributed network services and system management tasks. Various systems have been created to enable centralized control of resources/systems in distributed environments, which can include mainframes, workstations, personal computers, and the like.

A management server is a server that holds or references a complete set of software, including the full object database, for a management environment, which comprises a management server and associated managed nodes. The management server includes the libraries, binaries, data files, and graphical user interfaces needed to install and manage the components/systems in the managed environment. The management server maintains the server database and coordinates all communications with managed nodes utilizing a system management software utility.

A conventional managed node is a computer system that runs similar software as the management server and maintains its own database, which is also accessible to the management server. A resource, or managed resource, as the term is used in the present application, is any hardware or software entity (machine, service, system or facility) that is represented by a database object (referred to as a definition file). One standard resource that is managed by a management server is a computer system.

When manufactured, each new computer system includes/exhibits specific characteristics related to its physical dimensions, power consumption, constituent FRU parts, etc. In order to enable comprehensive management of these systems, system management software needs to be aware of the characteristics specific to each unique system that it is managing.

There are a few solutions currently available for completing the task of providing comprehensive management of these multiple, different systems connected to the management environment. For example, some information about the physical system (such as FRU part numbers and power consumption) are stored in Vital Product Data on the system. The primary drawback of this approach is that agent software running on the managed system is required to collect individual pieces of information that are dispersed throughout the system in order to aggregate them to the central management software. In fact, agent software may not have access to all of the information about the system that is required by the agent software. If the type of information require changes, there is currently no mechanism for making this information available for systems that are already deployed in end user environments.

Another solution involves manually creating a definition file for each new piece of hardware/software. This definition file is then bundled with subsequent releases of the management software. Two major drawbacks are associated with this implementation. The first drawback is that the creation of the definition file is a time-consuming, manual process. Thus, definition files tend to be generic to a machine type and avoid information that might vary with a model. The second drawback is that a release of an updated version of management software is required in order to support new systems. This requirement for a release of the management software forces churn in the customer software install, as well as potential lags between system availability and the availability of software required to support the system.

The present invention recognizes that it would therefore be beneficial to provide an automated process of generating the system definition file and making the system definition file available to system management software without the drawbacks of the aforementioned solutions. This and other benefits are provided by the invention described herein.

### SUMMARY OF THE INVENTION

Disclosed is a method, system and computer program product for enabling management software to quickly and efficiently access system specific information required for managing components of a distributed system environment. Specifically, the invention provides an automated process of generating the system definition files and making the system definition file available to existing system management software as a function of the existing management software operations. A publicly available definitions database is provided that is readily available (and easily accessible) to the management server. The definitions database maintains an updated list of definition files for all possible/designed component types that may be connected to the managed network. The management software executing on the management server is enhanced to include a utility that accesses the public (external) definitions database when required during a setup/registration of a managed component.

According to the illustrative embodiment, when management software queries a target managed system, the management software first queries the system type identification (i.e., a unique identifier for the bill of materials, such as the machine type-model, machine type generally available variant, or build to order number). Management software then queries the local repository (of the management server) to determine if a system definition file exists for the unique system type. When a definition file is not found within the server's repository, the management software initiates an attempt to connect to a public (external) management website/database to download the appropriate definition file. The definition file is downloaded from the public website and stored within the local storage of the management server.

The above as well as additional objectives, features, and advantages of the present invention will become apparent to those of ordinary skill in the art in view of the following detailed description of the illustrative embodiments.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1 and 2 are exemplary block diagrams of a resource management system/environment with publicly available/accessible definitions file database according to two embodiments of the invention;

FIG. 3 is an exemplary block diagram of a resource management server within which the software management features of the present invention are executed according to one embodiment of the present invention;

FIG. 4 is an exemplary block diagram of a managed computer system, representing an endpoint device, according to one embodiment of the present invention;

FIG. 5 is an exemplary diagram illustrating the primary software modules/components of management software with extended features in accordance with one embodiment of the present invention;

FIG. 6A is a flow chart of the process of retrieving machine-type model information from a new resource connected to the management environment in accordance with one embodiment of the invention; and

FIG. 6B is a flow chart illustrating the process of setting-up a definitions file for a new resource connected to the management environment according to one embodiment of the invention.

### DETAILED DESCRIPTION OF AN ILLUSTRATIVE EMBODIMENT

The present invention provides a method, system, and computer program product for enabling management software to quickly and efficiently access system-specific information required for managing components/systems of a managed networked. Specifically, the invention provides an automated process of generating system definition files and making the system definition files publicly available to system management software on a management server. A publicly available definitions database is provided that is easily accessible to the management server. The definitions database holds an updated list of definition files for all possible/designed component types that may be connected to the managed network. The management software executing on the management server is enhanced to include a utility that accesses the public (external) definitions database when required during a setup/registration of a new managed component.

In a preferred embodiment, the present invention is implemented in a management environment in which the managed nodes and resources are computer systems (or similar devices) with associated unique configuration of hardware and software components. Such a management environment may be comprised of one or more management servers and one or more managed nodes.

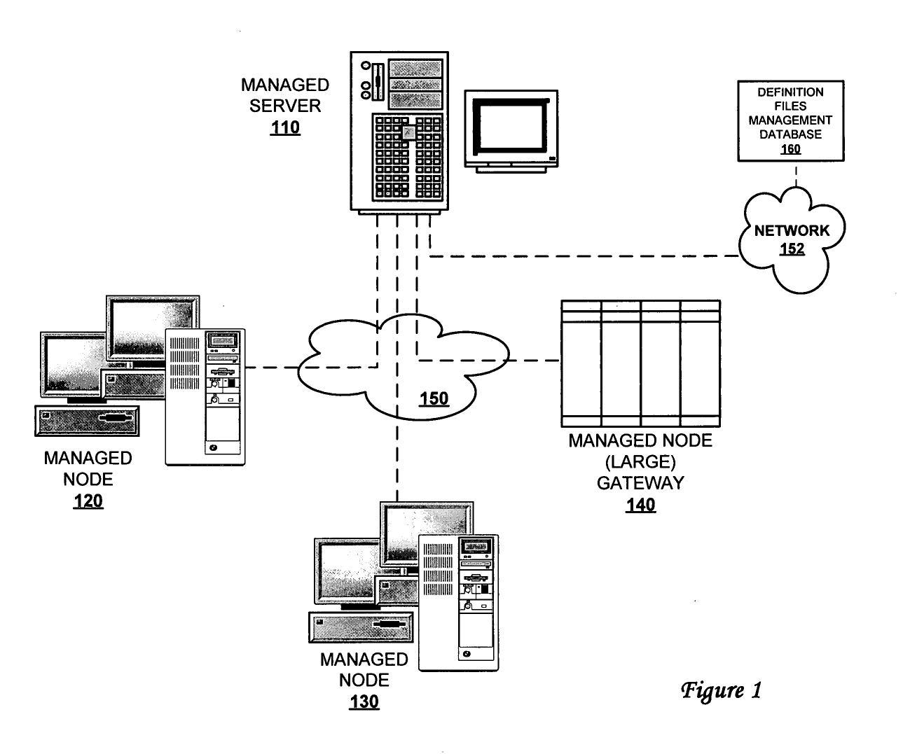

FIG. 1 illustrates one configuration of a management framework/environment. Management server 110 is communicatively coupled to managed nodes 120-140 via network backbone to created a managed network 100. Management server 110 manages the resources of managed nodes 120-140, which may also manage their own resources. Management server 110 maintains a local database (not shown) with network/configuration and other information relating to each of the managed nodes 120-140. The managed nodes 120-140 may themselves maintain a local database relating to their own respective resources.

In addition to the local network of management environment, management environment also comprises a network connection (or link) to an external network 152 to which is connected a management database 160. Management database 160 is referred to hereinafter as definition files management database (DMDB), reflecting/symbolizing the specific type of information being stored/maintained within the database. Thus, DMDB 160 maintains a list of definition files for a plurality of different types of systems/components/resources that may be connected to a managed environment.

DMDB 160 is provided as a service that is publicly accessible to management software utility via the network 152. Network 152 may be any type of publicly accessible network, including LAN or WAN. According to the described embodiment, network 152 represents the Internet, and the database functionality is accessed by a specific Internet Protocol (IP) address on the Internet and/or particular universal resource locator (URL) of a website that operates as a portal to DMDB 160.

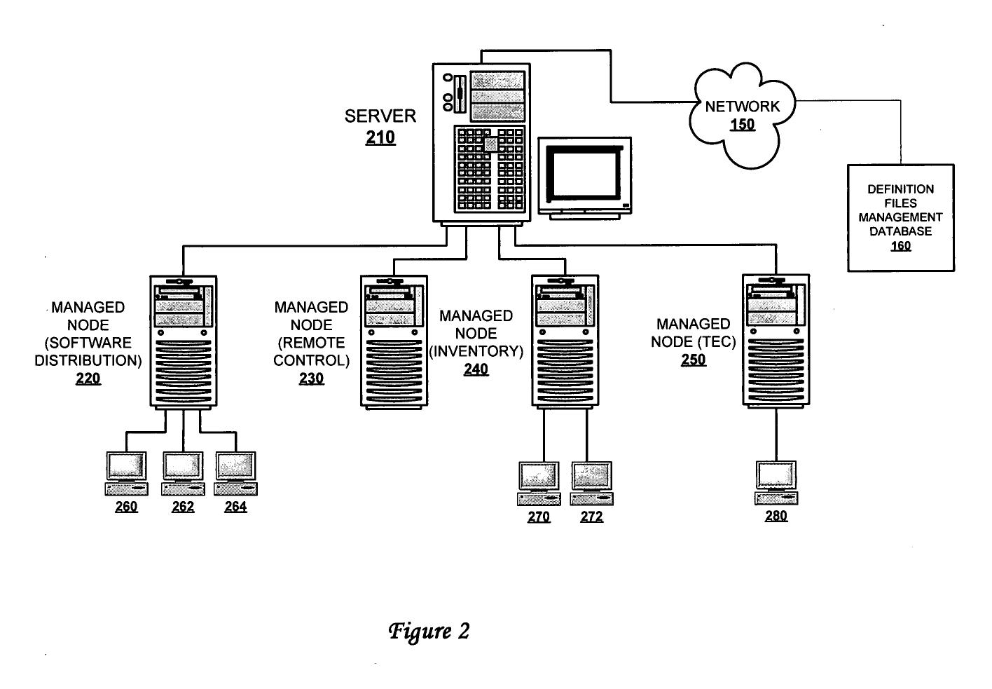

As indicated by FIG. 1, all components of the managed environment are interconnected via the local network 150, which is in turn connected to the external network 152 on which DMDB 160 is hosted. In this configuration, the managed environment may in fact encompass components connected via a global network (e.g., the external network). However, as illustrated by FIG. 2 a different configuration may be provided in which the external network is independent of the local network and is accessible only to the management server via a direct link from the management server.

FIG. 2 provides a three-tiered configuration of the managed network, including management server 150, which is coupled to gateways 160 and 170, and a managed node 180. Endpoints 260-280 (hereinafter client computer systems) are in turn connect to the gateways 160 and 170, and servers of the managed node 180. In the described embodiment, as shown in FIG. 2, this configuration does not provide connection of other nodes (besides the management server) to the publicly accessible DMDB files.

As shown by FIG. 2 the management server 210 is the central and hierarchical head that manages all systems below it in the hierarchy. The managed nodes 220-250 are second tier systems that may have systems management components of the systems management software which perform one or more of a plurality of different system management functions. These system management functions include, for example, software distribution, distributed monitoring, remote control, inventory, event management console, and the like.

These managed nodes 220-250 are used to manage the resources of the client computer systems 260-280. The third tier of the TME hierarchy is populated by client computer systems 260-280. These client computer systems 260-280 include resources (hardware and software) that are to be managed by the management server 210 and the managed nodes 220-250 of the first and second tiers, respectively. According to the described embodiments, the client computer systems 260-280 include software components called management agents that perform administrative operations in accordance with the management framework to manage the resources on the client computer systems 260-280, send and receive information to and from the managed nodes 220-250 and the management server 210, install new software components, and handle profiles provided to the agents by the managed nodes 220-250, etc.

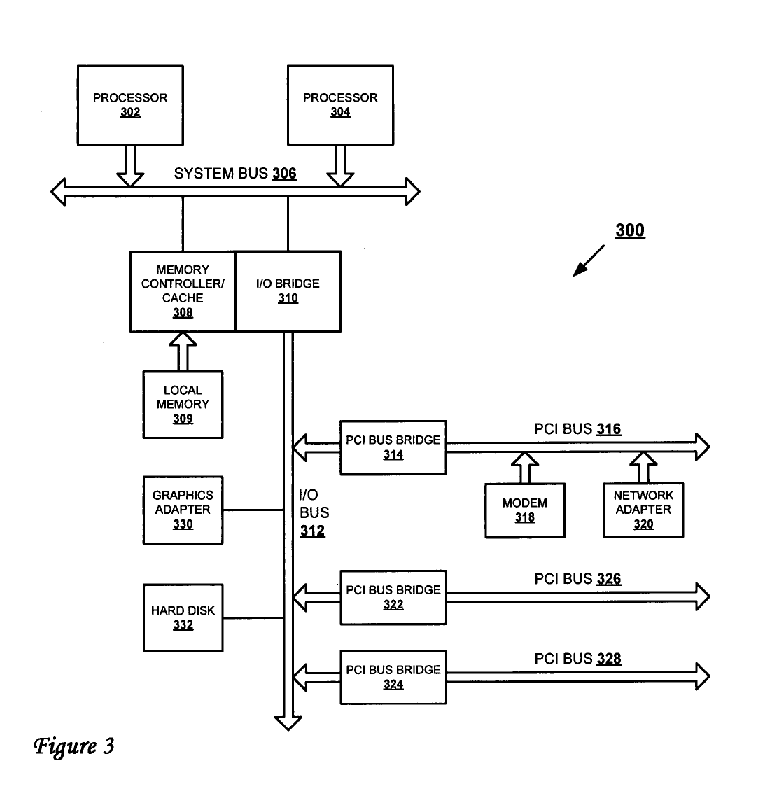

The present invention is preferably implemented on the management server 210, which (along with the managed nodes) are server-configured computing devices. FIG. 3 is a block diagram of an exemplary server device, such as management server 210 (or the managed nodes 220-250), in accordance with the present invention. Server 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated, as depicted.

Peripheral component interconnect (PCI) bus bridge 314 connected to I/O bus 312 provides an interface to PCI local bus 316. A number of modems may be connected to PCI local bus 316. Typical PCI bus implementations will multiple four PCI expansion slots or add-in connectors. Communications links to managed nodes and gateways in FIG. 2 may be provided through network adapter 320 connected to PCI local bus 316 through add-in boards. Additional PCI bus bridges 322 and 324 provide interfaces for additional PCI local buses 326 and 328, from which additional network adapters may be supported. In this manner, data processing system 300 allows connections to multiple network computers and devices (managed systems). A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention. The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

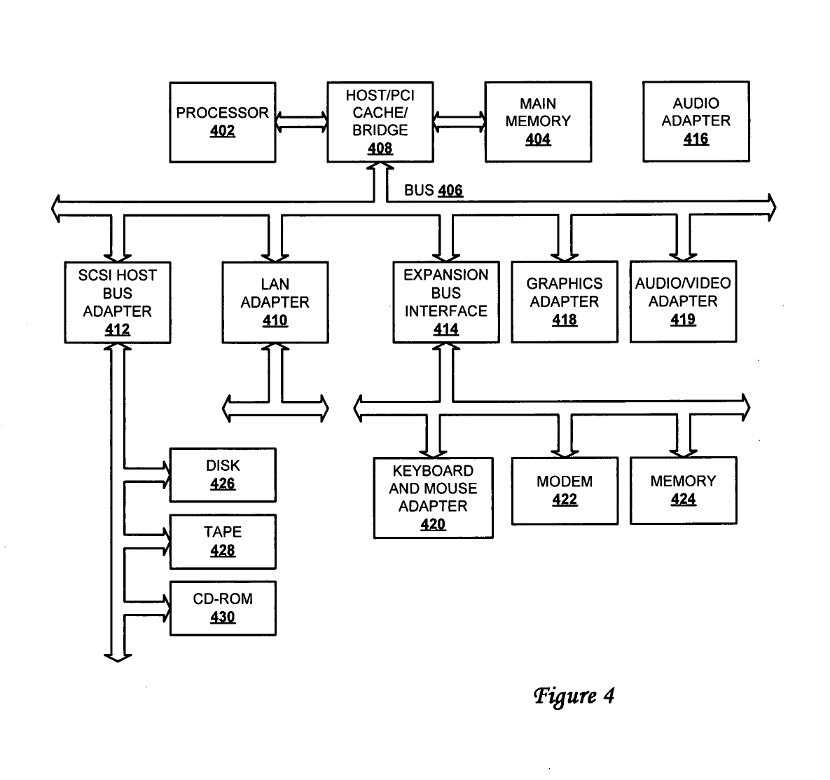

FIG. 4 is a block diagram of an exemplary client computer system, similar to client computer systems 260-280 of FIG. 2. Client computer system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards.

In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions (or program code) for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. As another example, data processing system 400 may be a stand-alone system configured to be bootable without relying on some type of network communication interfaces. As a further example, data processing system 400 may be a personal digital assistant (PDA) device, which is configured with ROM and/or flash ROM in order to provide non-volatile memory for storing operating system files and/or user-generated data. Client computer system 400 may also be a notebook computer or hand held computer in addition to taking the form of a PDA. Client computer system 400 also may be a kiosk or a Web appliance. Also, the processes of the present invention may be applied to a multiprocessor data processing system. Thus, the depicted example in FIG. 4 and above-described examples are not meant to imply architectural limitations.

In order to provide management support of a new system, a definition file relating to the system is required by the management server. Thus, the invention involves a first aspect that involves a new business process whereby information is generated as part of the supply chain management/manufacturing process. That is, as a new product is developed and/manufactured, the manufacturer (via a fulfillment application, e.g., SAP) builds a parts list for each system to be built as part of the fulfillment process. The part list is specific to a unique identifier for the bill of materials, such as the machine type-model (MTM), machine type generally available variant (MT-GAV), or build to order (BTO) number (described below). The part list is compiled with other information about the new system's characteristics and other data relevant to enable system-specific management of the resources provided by the new system.

An additional step is added to the fulfillment application process. This step involves exporting the part list and additional physical characteristics for the respective systems into a data file. The data file, referred to herein as a definition file, is given a name identifying the unique identifier for the bill of materials along with an extension utilized to identify the files utilized by the management server when managing specific resources. In one embodiment, the extension given to each of these data files is “.def”, and a definition file is named “X.def”, where “X” represents the unique identifier string. The generated data file (definition file) is then stored within a database that is made available on an external website for access from management software running in customer environments. The database may be setup and supported/maintained by the manufacturer of the management software as an additional service to its customers. Notably, the data file (definition file) is parsable by management software utility. Several of the above steps may be provided by a data processing system having software executing on a processor, similar to server of FIG. 3 and/or computer system of FIG. 4.

When parts are entered into the fulfillment application, the characteristics of interest for these new parts are also entered. These characteristics are saved and exported into the definition (data) file for systems that contain that part in their Bill of Materials (BOM). The new part and associated characteristics are defined by a part number via a user customization interface. The user customization interface enables the user to enter the characteristics that they user wishes to define for the part (i.e., the specific part along with the rules to be associated with the system). These characteristics are defined in the fulfillment process before the definition file is generated and sent to the server. The combination of parts results in unique machine types, referred to as a build to order (BTO) machine.

Through a separate user interface, (perhaps the ordering interface of the system vendor), a user (such as a customer) can define a distinct system. When the user has completed the customization of their system, the fulfillment application generates a BTO number against the base Machine Type. This BTO number serves as the identifier for systems with the new configuration, in lieu of the MTM and/or MT-GAV. For example, one manufacturer, International Business Machines (IBM) Inc., identifies systems with a machine type model identifier of the form xxxx-yyy (where xxxx is the machine type and yyy is the model). For custom (i.e., BTO) systems ordered with the customization interface (e.g., a browser with web access), the conventional MTM or MT-GAV identifiers for the base machine type is replaced with xxxx-BTO followed by a separate multi-digit identifier. The multi-digit identifier is a number of digits large enough to be unique for the machine type, and that identifier is assigned for that custom configuration. The resulting pair (xxxx-BTO, BTO number) uniquely identifies the system throughout the fulfillment process and is also utilized by the management software. This implementation enables the ability to customize results in potentially thousands of combinations against a base machine type. One embodiment of the invention thus involves a method for programmatically generate the definition files.

A second aspect of the invention requires the management software to be updated with a utility that is able to access the external website/database during processing of new systems. The utility includes the network address of the website/database as well as other functional software components to initiate access to the website/database, parse the database for the correct definition file, and return the definition file to the management environment.

According to the illustrative embodiment, described in greater details below, when management software queries a target managed system, the management software first queries the system type unique identifier (i.e., such as the MTM, MT-GAV, or BTO number). Management software then queries the local repository (of the management server) to determine if a system definition file exists for the unique system type. When a definition file is not found within the server's repository, the management software initiates a connection to the public website/database to download the appropriate definition file for the target system. The definition file is downloaded from the public website and stored within the management server's local repository.

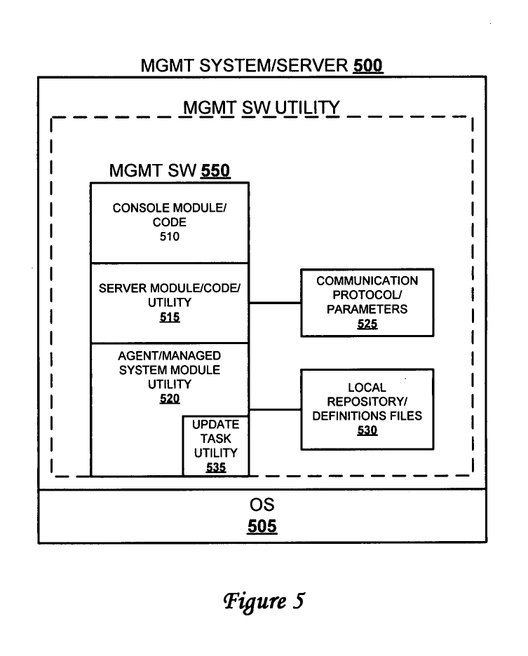

As illustrated by the embodiment of FIG. 5, software components 500 of the management server includes operating system (OS) 505 and management software 550, and other software modules required to complete network communication, e.g., communication protocol module 525. Additionally, stored within the local storage facility are local “definition file” repository 530 with files of existing managed systems/components on the managed network.

Management software 505 is generally divided into three functional layers, each with a respective module/utility for carrying out specific server and management features of the invention. These modules include: console module 510, server module 515, and agent/managed system module 520. Within agent/managed system module 520 is an update task utility 525, whose functionality is described below. With the above configuration of management software 505, a substantial portion of management logic executes at the management server 250, with the agent module 520 providing a communications endpoint and the console module 510 providing the presentation layer for administrative access. Server module 515 provides the specific server functionality that enables connection to (and subsequent management of) the other components of the managed network via communications module 525. Also, communication module 525 is utilized by update task utility 525 to establish a connection to public DMDB when required.

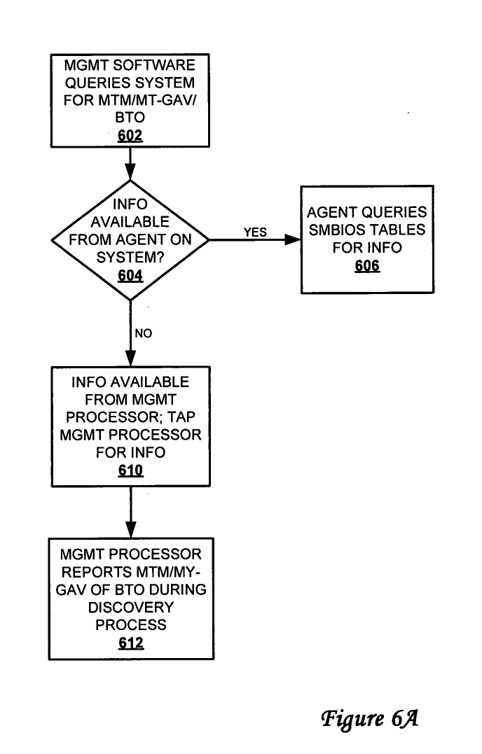

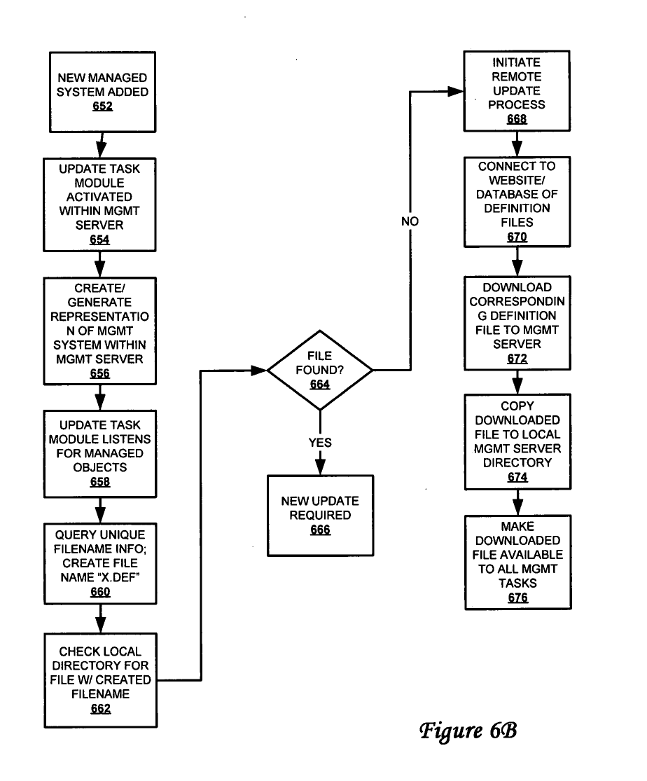

FIG. 6A provides a flow chart of the process involved in retrieving the unique identifier (e.g., MTM) of a new system to be managed by the management server. Beginning at block 602, the management server 250 queries the newly connected/added system for the system's unique identifier. Because the information may be obtained in one of two ways, a determination is made at block 604 whether the information is available from the agent running on the managed system. If the information is collectable from the agent, the agent queries the information from SMBIOS tables, as shown at block 606. Then the information retrieved from the SMBIOS tables is sent to the management server via agent messaging protocol at block 608.

However, if the information is not available from the agent, the information must then be obtained from an “out of band” source via a management processor installed in the managed system. The management processor is tapped to provide the information at block 610. The information is generally passed to the management processor by the BIOS during POST (power on self test). The management processor thus reports the machine-type model as part of the discovery process, as indicated at block 612. The processes completed within the various blocks described in FIG. 6A are executed by the processor of the server 300 described in FIG. 3 above.

FIG. 6B illustrates the process by which definition file updates are completed when newly added systems are detected by the management server on the managed environment. The new system is added at block 652, and the management software (which monitors for addition of new components) activates the update task module, which begins execution within the management server, as shown at block 654. A representation of the management system (i.e., a managed object) is created within the software engine of the management server as indicated at block 656. Creation of the managed object involves retrieving the base attributes of the managed object, which contain the management-type model information (received according to one path of the process illustrated by FIG. 6A and described above). The update task utility listens for the creation of these representations (managed objects) at block 658. The update task utility then queries the model-type model information from the managed object and generates a filename by concatenating a specific filename extension (e.g., “.def”) onto the MTM or MT-GAV string, as shown at block 660. Notably, this process is different for BTO numbers, as described above.

The update task module then checks, at block 662, a local directory of the management server for a definition file with the generated name (i.e., mtm_string.def). A determination is made at block 664 whether the file is found, and when the file is found, then no update is required as indicated at block 666. However, if the file is not found in the local directory, then update task utility initiates a remote database search at block 668. As shown at block 670, the update task utility connects via a pre-programmed network communication protocol (such as hyper text transport protocol, http) to pre-established, configurable website (or database) where substantially all definition files are located. Once access to the website/database occurs, the update task utility activates a search-and-download process at the website/database by forwarding the name of the definition file being requested, as shown at block 672. The definition file is found and downloaded to the local directory, as shown at block 674, where it is stored. The definition file is thus made available for managing the new system and for utilization by other tasks within the management server, as indicated at block 676. The processes completed within the various blocks described in FIG. 6B are executed by the processor of the server 300 described in FIG. 3 above.

Among the advantages provided by the invention, one key advantage is that the invention enables system management software to receive updated files of new/additional characteristics of the managed system without requiring user intervention. Another key advantage is that implementation of the invention does not require installation of software updates, thus reducing development and customer hardware support costs. The invention finds applicability within fulfillment software and processes in different technology areas.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
checking a local database of a management server for a definition file of a new component added to a managed network, wherein management of said new component by said management server requires access to the definition file for that new component;
when a definition file for the new component is not found within the local database of the management server:
automatically accessing, via an external network, an externally-located definitions database that maintains a specific definition file for each component that may be added as a resource to said managed network; and
downloading the specific definition file for the new component from the definitions database; and
setting up said new component as a managed component utilizing said management software and parameters from said definition file.

2. The method of claim 1, further comprising:
first retrieving a unique identifier (UID) from the new component, wherein said UID includes one from among a machine type model (MTM), a machine type generally available variant (MT-GAV), and a build to order (BTO) number, said unique ID represented as a string of characters;
adding an extension to the character string to create a definition file name; and
conducting said search at said local database and at said external database utilizing said created definition file name.

3. The method of claim 2, wherein when said unique ID is a BTO number, said file name includes the machine type, an indication that the number is a BTO, and the BTO number itself with the extension appended.

4. The method of claim 1, further comprising:
downloading said definition file to the management server; and
storing the definition file in the management server's local database.

5. The method of claim 1, further comprising:
first querying a system type identification from the new system;
querying the local repository for a system definition file for a unique system type;
automatically initiating a connection to the public database; and
forwarding a request to the public database to download the specified definition file.

6. The method of claim 1, further comprising:
generating a request for issuing to the external database, said request including the definition file name and a network routing address of the external database; and
issuing the request to the network, wherein said request is taken to the external database via use of the external address.

7. A method comprising:
compiling a list of operating parameters/characteristics and parts for a new component during a fulfillment process of said new component that is geared towards providing detailed breakdowns of constituent parts of the new component;
identifying which characteristics of the each among all characteristics that are to be exported to the definition file for systems containing the part;
creating a definition file from the series of operating parameters compiled, wherein the definition file provides the list of the operating characteristics and parts for that new component to be utilized during system-specific management of the new component, and the data file generated exactly matches the parts in the system;
determining a unique identifier (ID) for the new component, wherein the unique identifier includes a machine type model (MTM) or MT-GAV for general systems and a BTO number for customized systems; and
labeling the definition file with the unique ID string and a file extension.

8. The method of claim 7, further comprising:
forwarding the definition file to a server that hosts the definition file along with other generated definition files for easy access by management servers.

9. The method of claim 7, further comprising storing the definition file within a publicly accessible server database that maintains definition files for access and download by management servers of various managed networks.

10. The method of claim 7, further comprising extending a last version of management software being implemented within the management network with an update utility that enables said management software to access the server database for said definition file, wherein said access is completed via a request issued on an external network on which said server database exists.

11. A computer program product comprising:
a computer readable medium; and
program code on the computer readable medium for efficiently expanding management software functionality of the management server, said program code comprising code for:
checking a local database of the management server for a definition file of a new component added to the network, wherein management of said new component by said management server requires access to the definitions file for that new component;
when a definition file for the new component is not found within the local database of the management server:
automatically initiating an access, via an external network, to an externally-located, definitions database that maintains a specific definition file for each component that may be added to said managed network; and
downloading the specific definition file for the new component from the definitions database; and
setting up said new component as a managed component utilizing said management software and parameters from said definition file.

12. The computer program product of claim 11, further comprising code for:
first retrieving a unique identifier (UID) from the new component, wherein said UID includes one from among a machine type model (MTM), a machine type generally available variant (MT-GAV), and a build to order (BTO) number, said unique ID represented as a string of characters;
adding an extension to the character string to create a definition file name; and
conducting said search at said local database and at said external database utilizing said created definition file name.

13. The computer program product of claim 12, wherein when said unique ID is a BTO number, said file name includes the machine type, an indication that the number is a BTO, and the BTO number itself with the extension appended.

14. The computer program product of claim 11, further comprising code for:
downloading said definition file to the management server; and
storing the definition file in the management server's local database.

15. The computer program product of claim 11, further comprising code for:
first querying a system type identification from the new system;
querying the local repository for a system definition file for a unique system type;
automatically initiating a connection to the public database; and
forwarding a request to the public database to download the specified definition file.

16. The computer program product of claim 11, further comprising program code for:
generating a request for issuing to the external database, said request including the definition file name and a network routing address of the external database; and
issuing the request to the network, wherein said request is taken to the external database via use of the external address.

17. A computer program product comprising:
a computer readable medium; and
program code on said computer readable medium for:
displaying a user interface for entry of customization information by a user;
compiling a list of operating parameters/characteristics and parts for a new component during a fulfillment process of said new component that is geared towards providing detailed breakdowns of constituent parts of the new component;
identifying which characteristics of the each among all characteristics that are to be exported to the definition file for systems containing the part;
creating a definition file from the series of operating parameters compiled, wherein the definition file provides the list of the operating characteristics and parts for that new component to be utilized during system-specific management of the new component;
determining a unique identifier (ID) for the new component, wherein the unique identifier includes a machine type model (MTM) or MT-GAV for general systems and a BTO number for customized systems; and
labeling the definition file with the unique ID string and a file extension.

18. The computer program product of claim 17, further comprising code for:
forwarding the definition file to a server that hosts the definition file along with other generated definition files for easy access by management servers.

19. The computer program product of claim 17, further comprising code for storing the definition file within a publicly accessible server database that maintains definition files for access and download by management servers of various managed networks.

20. The computer program product of claim 17, further comprising code for extending a last version of said management software being implemented within the management network with an update utility that enables said management software to access the server database for said definition file, wherein said access is completed via a request issued on an external network on which said server database exists.

21. A managed network comprising:
a management server having a processor executing management software and a local database;
at least one managed component; and
a link for accessing an external network;
wherein said management software includes instruction means for:
checking a local database of the management server for a definition file of a new component added to the network, wherein management of said new component by said management server requires access to the definitions file for that new component;
when a definition file for the new component is not found within the local database of the management server:
automatically accessing, via an external network, an externally-located public definitions database that maintains a specific definition file for each component that may be added as a resource to said managed network; and
downloading the specific definition file for the new component from the public definition database; and
setting up said new component as a managed component utilizing said parameters from said definition file and said management software.

22. The managed network of claim 21, said management software further comprising instructions for:
first retrieving a unique identifier (UID) from the new component, wherein said UID includes one from among a machine type model (MTM), a machine type generally available variant (MT-GAV), and a build to order (BTO) number, said unique ID represented as a string of characters;
adding an extension to the character string to create a definition file name; and
conducting said search at said local database and at said external database utilizing said created definition file name.

23. The managed network of claim 22, wherein when said unique ID is a BTO number, said file name includes the machine type, an indication that the number is a BTO, and the BTO number itself with the extension appended.

24. The managed network of claim 21, further comprising instructions for:
downloading said definition file to the management server; and
storing the definition file in the management server's local database.

25. The managed network of claim 21, further comprising instructions for:
first querying a system type identification from the new component;
querying the local repository for a system definition file for a unique system type;
automatically initiating a connection to the public database; and
forwarding a request to the public database to download the specified definition file.

26. The managed network of claim 21, further comprising instructions for:
generating a request for issuing to the external database, said request including the definition file name and a network routing address of the external database; and
issuing the request to the network, wherein said request is taken to the external database via use of the external address.

27. A computer system comprising:
a processor; and
instructions executing on the processor for:
displaying a user interface for entry of customization information by a user;
compiling a list of operating parameters/characteristics and parts for a new component during a fulfillment process of said new component that is geared towards providing detailed breakdowns of constituent parts of the new component;
identifying which characteristics of the each among all characteristics that are to be exported to the definition file for systems containing the part;
creating a definition file from the series of operating parameters compiled, wherein the definition file provides the list of the operating characteristics and parts for that new component to be utilized during system-specific management of the new component;
determining a unique identifier (ID) for the new component, wherein the unique identifier includes a machine type model (MTM) or MT-GAV for general systems and a BTO number for customized systems; and
labeling the definition file with the unique ID string and a file extension.

28. The computer system of claim 27, further comprising instructions executing on the processor for:
forwarding the definition file to a server that hosts the definition file along with other generated definition files for easy access by management servers.

29. The managed network of claim 27, wherein said instructions further comprise instructions for storing the definition file within a publicly accessible server database that maintains definition files for access and download by management servers of various managed networks.

30. The managed network of claim 27, wherein said instructions further comprise instructions for extending a last version of said management software being implemented within the management network with an update utility that enables said management software to access the server database for said definition file, wherein said access is completed via a request issued on an external network on which said server database exists.
